(19) United States
(12) Patent Application Publication
(10) Pub. No.: US 2011/0305230 A1
(43) Pub. Date: Dec. 15, 2011

(54) WiMAX Integrated Network Server

(75) Inventors: Young-Ki Yoon, Seoul (KR); Jung-Goo Lee, Daejeon (KR); Kyo-Sang Oh, Giheung-gu (KR); Young-Chun Chu, Suji-gu (KR); Young-Beom Kwon, Seoul (KR); Yong Soon Kang, Gyeonggi-Do (KR)

(73) Assignees: LANBIRD TECHNOLOGY CO., LTD, Seoul (KR); SK TELESYS., CO. LTD, Seoul (KR)

(21) Appl. No.: 13/048,797

(22) Filed: Mar. 15, 2011

(30) Foreign Application Priority Data
Jun. 11, 2010 (KR) 1020100055233

(51) Int. Cl. H04W 4/00

(52) U.S. Cl. 370/338

(57) ABSTRACT

A Worldwide Interoperability for Microwave Access (WiMAX) integrated network server is disclosed. The WiMAX integrated network server is integrally includes an Access Service Network Gateway (ASN-GW), an Authentication Authorization Accounting (AAA) connected to the ASN-GW, and a Home Agent (HA). The ASN-GW follows the WiMAX standard, manages a mobile station connected to a base station, and provides connection paths connected to a network. The AAA authenticates the mobile station to be connected to the network. The HA provides a Mobile IP service to guarantee the mobility of the mobile station. The WiMAX integrated network server includes a separate data processing unit, which makes it possible to rapidly process data. The WiMAX integrated network server can independently manage communication among the mobile stations connected thereto, separately from an external network. The WiMAX integrated network server does not require additional equipment, which reduces the installation space and costs.

### CROSS REFERENCE TO RELATED APPLICATION

This application claims priority to and the benefit of Korean Patent Application No. 10-2010-0055233, filed in the Korean Intellectual Property Office on Jun. 11, 2010, the entire contents of which are incorporated herein by reference.

### BACKGROUND OF THE INVENTION

1. Field of the Invention

The present invention relates to network systems, and more particularly, to a Worldwide Interoperability for Microwave Access (WiMAX) integrated network server following the WiMAX standard.

2. Description of the Related Art

Worldwide Interoperability for Microwave Access (WiMAX) defines WiMAX communication network architecture based on wireless data transmission technology according to IEEE 802.16 standard.

In the WiMAX communication standard, mobile stations can be connected to a mobile communication network via communication systems, such as a base station, an Access Service Network Gateway (ASN-GW), an Authentication Authorization Accounting (AAA), a Home Agent (HA), etc. That is, mobile stations are connected to a mobile communication network via a base station and an ASN-GW.

The base station controls wireless resources of mobile stations and the ASN-GW manages the connection with base stations, and authentication/billing, data communication, information, etc., of mobile stations. The AAA serves to process subscribers' authentication, authorization, and billing, etc. The AAA authenticates and authorizes a mobile station connected via the ASN-GW, so that the mobile station can be connected to a mobile communication network. The AAA also manages the billing of the mobile station connected to the mobile communication network. The HA serves to allocate and manage fixed IPs for mobile stations and to perform a data routing operation, based on mobile IP technology.

In order to connect to a mobile communication network and smoothly provide services to users, the mobile stations require using the WiMAX communication systems described above. However, each of the WiMAX systems is expensive and so large in volume that it is restricted by the installation space, which causes difficulties in providing an in-building service.

### SUMMARY OF THE INVENTION

The present invention solves the above problems, and provides a Worldwide Interoperability for Microwave Access (WiMAX) integrated network server following the WiMAX standard, which is not restricted by space due to its size and is cost efficient.

In accordance with an exemplary embodiment of the present invention, there is provided a WiMAX integrated network server including: an Access Service Network Gateway (ASN-GW) following the WiMAX standard, managing a mobile station connected to a base station, and providing connection paths connected to a network; and an Authentication Authorization Accounting (AAA) connected to the ASN-GW, for authenticating the mobile station to be connected to the network.

Preferably, the WiMAX integrated network server may further include a Home Agent (HA) for providing a Mobile IP service to guarantee the mobility of the mobile station.

Preferably, the WiMAX integrated network server may further include: a computing unit for performing computation to operate the functions of the ASN-GW and the AAA; a storage unit for storing information to execute the ASN-GW and the AAA; an interface unit for communicating with an external device; and a power supply for supplying electric power to the computing unit, the storage unit, and the interface unit.

In accordance with another exemplary embodiment of the present invention, there is provided a WiMAX integrated network server including: a hardware unit comprised of a plurality of hardware components including an interface unit connected to an external device; an operating system for processing signals, input via the hardware unit, on the hardware unit, and controlling and managing the hardware unit; and an application unit including an Access Service Network Gateway (ASN-GW) and an Authentication Authorization Accounting (AAA). The ASN-GW manages a mobile station connected to a base station and provides connection paths connected to a network, on the operating system, according to the WiMAX standard, and the AAA authenticate the mobile station.

Preferably, the application unit further includes a Home Agent (HA) for providing a Mobile IP service to guarantee the mobility of the mobile station.

Preferably, the WiMAX integrated network server may further include a data processing unit for data, input via the hardware unit, on the hardware unit. The data processing unit transfers the processed data to an external device, without passing through the operating system.

Preferably, one of a plurality of mobile stations connected to the network generates data and directly transfers it to another via the application unit.

### BRIEF DESCRIPTION OF THE DRAWINGS

The features and advantages of the present invention will become more apparent from the following detailed description in conjunction with the accompanying drawings, in which:

FIG. 1 is a detailed view illustrating a hardware unit of a WiMAX integrated network server according to an embodiment of the present invention;

FIG. 2 is a schematic block diagram illustrating a WiMAX integrated network server according to an embodiment of the present invention; and

FIG. 3 is a view illustrating a communication network including a WiMAX integrated network server according to an embodiment of the present invention.

### DETAILED DESCRIPTION OF SPECIFIC EMBODIMENTS

Hereinafter, exemplary embodiments of the present invention are described in detail with reference to the accompanying drawings. The description and drawings are for the purpose of illustration and not limitation Like reference numerals will be understood to designate like elements throughout the specification. Those of ordinary skill in the art would recognize variations, modifications, and alternatives. Such variations, modifications, and alternatives are also within the scope of the present invention. Detailed descriptions of well-known functions and structures incorporated herein may be omitted to avoid obscuring the subject matter of the present invention.

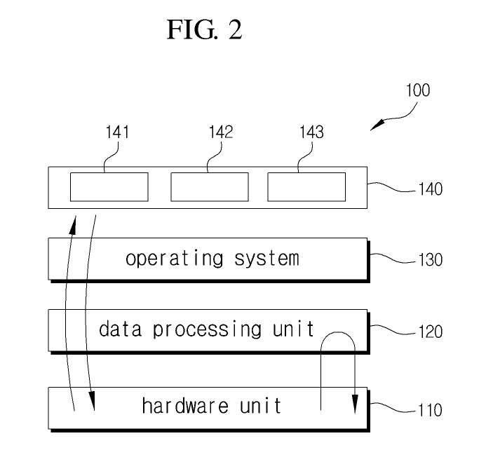

In an embodiment of the present invention, as shown in FIG. 2, the WiMAX integrated network server 100 includes a hardware unit 110, a data processing unit 120, an operating system 130, and an application unit 140.

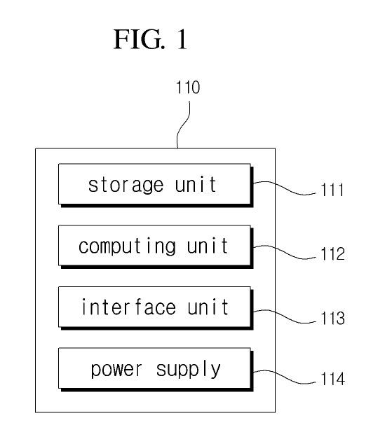

The hardware unit 110, as shown in FIG. 1, includes a storage unit 111, a computing unit 112, an interface unit 113, and a power supply 114. It serves to perform a physical computation in the WiMAX integrated network server 100.

The storage unit 111 stores information to assist the operating system 130 and the application unit 140.

The computing unit 112 performs a computing process using the information stored in the storage unit 111 and executes the functions of the operating system 130 and the application unit 140.

The interface unit 113 serves to communicate with external devices. It can perform communication based on various communication standards. It can allow the WiMAX integrated network server 100 to be connected to a plurality of base stations and a plurality of mobile stations. It can also allow the WiMAX integrated network server 100 to be connected to the Internet or a mobile communication network.

The power supply 114 supplies electric power to the storage unit 111, the computing unit 112 and the interface unit 113.

The data processing unit 120 processes data received via the hardware unit 110 and directly outputs it to an external device via the interface unit 113, without requiring the operating system 130. That is, unlike signal packets processed by the application unit 140 and the operating system 130, the data packets are directly processed by the layers lower than the operating system 130, thereby increasing the data processing speed.

The operating system 130 is installed to the upper layer of the data processing unit 120. The operating system 130 controls and manages the entire operation of the hardware unit 110 and processes signals input via the hardware unit 110. The operating system 130 transfers the processed signals to the application unit 140 or to an external device via the interface unit 113 of the hardware unit 110. If control packets or signal packets that cannot be processed by the data processing unit 120 are transferred to the operating system 130 via the data processing unit 120, the operating system 130 processes the control packets or signal packets to meet the function of the application unit 140 and then transfers them to the application unit 140.

The hardware unit 110 receives various types of packets. The signal packets are processed by the application unit 140, via the operating system 130. The data packets are rapidly processed by the data processing unit 120, without passing though the operating system 130.

Since the data processing unit 120 processes only data without the assistance of the operating system 130 and the application unit 140, it can rapidly provide a data processing service to the mobile station.

The operating system 130 can be implemented with one of the software operating systems, for example, Microsoft Windows, Linux, etc. In an embodiment of the present invention, the operating system 130 is implemented with Linux.

The application unit 140 can allow for the installation of a variety of application programs. In an embodiment of the present invention, an Access Service Network Gateway (ASN-GW) 141, an Authentication Authorization Accounting (AAA) 142, and a Home Agent (HA) 143 are installed to the application unit 140.

The ASN-GW 141 manages connection between the lower layer and a plurality of base stations. In particular, the WiMAX integrated network server 100 is installed to an in-building, the ASN-GW 141 manages base stations placed in the building and is operated according to the WiMAX standard. The ASN-GW 141 manages a plurality of connected mobile stations, provides connection paths for network, routes packets, and performs a handover of a mobile station between base stations.

In addition, the ASN-GW 141 performs authentication, authorization, billing service, etc. The ASN-GW 141 can control the flow of the services, the mobility of a mobile station, and the quality of service provided to the mobile station.

The AAA 142 performs an authentication process allowing a mobile station to be connected to a network. The AAA 142 serves to authenticate the subscriber of a mobile station. The AAA 142 serves as an EAP-TLS/TTLS/AKA/SIM server via the remote authentication dial-in user service (RADIUS) protocol or DIAMETER protocol.

The HA 143 provides a mobile IP of a mobile station with respect to a WiMAX node. The HA 143 manages a Proxy Mobile IP (PMIP) and a Client Mobile IP (CMIP), and performs an IP-in-IP encapsulation.

In an embodiment of the present invention, the WiMAX integrated network server 100 conducts OAM functions, such as Status, Alarm, Statistics, Fault, Loading, Configuration, Call Trace, Diagnostics, etc.

Since the Access Service Network Gateway (ASN-GW) 141, the Authentication Authorization Accounting (AAA) 142, and the Home Agent (HA) 143 are operated in an application under one hardware based operating system, the WiMAX integrated network server 100 can be implemented as one system.

Although the embodiment of the present invention is implemented in such a way that the application unit 140 includes the ASN-GW 141, the AAA 142, and the HA 143, it should be understood that the present invention is not limited to the embodiment. For example, the application unit 140 can further include other units since they can be implemented as applications. In addition, the application unit 140 can include at least one or more from among the ASN-GW 141, the AAA 142, and the HA 143.

Since the WiMAX integrated network server 100 includes the ASN-GW 141, it can provide a wireless WiMAX service, by cooperating with base stations.

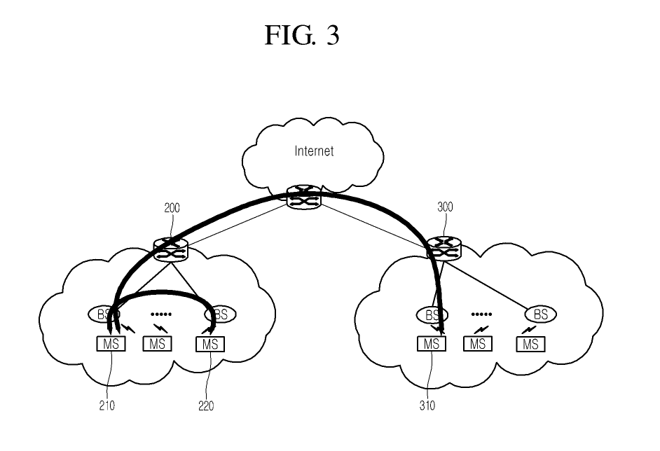

As shown in FIG. 3, if the first mobile station 210 transmits data to the second mobile station 220 where the first and second mobile stations 210 and 220 are connected to the lower layer of the first WiMAX integrated network server 200, the first WiMAX integrated network server 200 receives the data from the first mobile station 210 and directly transfers it to the second mobile station 220, without transferring it to the Internet or a mobile communication network. That is, the mobile stations, connected to the lower layer of the WiMAX integrated network server 200, can perform communication, for example, data transmission, with each other.

Therefore, one WiMAX integrated network server, installed to an intranet, an LAN, etc., can serve to construct an independent network, without requiring an external Internet or a mobile communication network. In that case, mobile stations can communicate with each other via the independent network, without using an external switch, an ISP service, etc.

On the other hand, if the first mobile station 210, connected to the lower layer of the first WiMAX integrated network server 200, makes a call to the third mobile station 310, connected to the lower layer of the second WiMAX integrated network server 300, or vice versa, they must perform communication via the Internet or a mobile communication network.

As described above, since the network server, according to the present invention, integrally includes the authentication unit for authenticating the ASN-GW and a mobile station, it can reduce equipment occupying a relatively large space, thereby acquiring a space advantage and reducing costs.

Since the network server includes a separate data processor for processing data, it can directly process data packets without passing through the operation system, thereby increasing the data processing speed.

Since the lower end of the WiMAX integrated network server can establish an independent network, it can be used as an intranet, a LAN, etc., which increases the communication speed.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A WiMAX integrated network server comprising:
an Access Service Network Gateway (ASN-GW) following the WiMAX standard, managing a mobile station connected to a base station, and providing connection paths connected to a network; and
an Authentication Authorization Accounting (AAA) connected to the ASN-GW, for authenticating the mobile station to be connected to the network.

2. The WiMAX integrated network server according to claim 1, further comprising:
a Home Agent (HA) for providing a Mobile IP service to guarantee the mobility of the mobile station.

3. The WiMAX integrated network server according to claim 1, further comprising:
a computing unit for performing computation to operate the functions of the ASN-GW and the AAA;
a storage unit for storing information to execute the ASN-GW and the AAA;
an interface unit for communicating with an external device; and
a power supply for supplying electric power to the computing unit, the storage unit, and the interface unit.

4. A WiMAX integrated network server comprising:
a hardware unit comprised of a plurality of hardware components including an interface unit connected to an external device;
an operating system for processing signals, input via the hardware unit, on the hardware unit, and controlling and managing the hardware unit; and
an application unit including an Access Service Network Gateway (ASN-GW) and an Authentication Authorization Accounting (AAA), wherein the ASN-GW manages a mobile station connected to a base station and provides connection paths connected to a network, on the operating system, according to the WiMAX standard, and the AAA authenticate the mobile station.

5. The WiMAX integrated network server according to claim 4, the application unit further comprises:
a Home Agent (HA) for providing a Mobile IP service to guarantee the mobility of the mobile station.

6. The WiMAX integrated network server according to claim 4, further comprising:
a data processing unit for data, input via the hardware unit, on the hardware unit,
wherein the data processing unit transfers the processed data to an external device, without passing through the operating system.

7. The WiMAX integrated network server according to claim 6, wherein one of a plurality of mobile stations connected to the network generates data and directly transfers it to another via the application unit.
